(19) United States
(12) Patent Application Publication
(10) Pub. No.: US 2012/0048890 A1
(43) Pub. Date: Mar. 1, 2012

(54) CHILLED DRINK DISPENSER

(76) Inventor: JUNIOR JULIAN HSU, NORTHBROOK, IL (US)

(21) Appl. No.: 12/872,261

(22) Filed: Aug. 31, 2010

(51) Int. Cl. B67D 7/80; B67D 7/76

(52) U.S. Cl. 222/146.6; 222/189.06; 222/108; 222/185.1

(57) ABSTRACT

A chilled drink dispenser includes: a drink container for containing a drink, the drink container having an ice chamber at its center, the ice chamber having an opening on its top for filling ice cubes; a strainer member having a reception sink for engaging with a bottom section of the drink container, a drain structure being formed in reception sink in alignment with the ice chamber, whereby melted iced water can be drained out through the drain structure; and a bottom basin, a top end of the bottom basin being engaged with an outer periphery of the strainer member. The bottom basin has a reservoir. After drained out through the drain structure, the melted iced water will fall into the reservoir.

### BACKGROUND OF THE INVENTION

1. Field of the Invention

The present invention relates generally to a chilled drink dispenser, and more particularly to a chilled drink dispenser that can preserve the original taste of the drink without being diluted by the melted iced water.

2. Description of the Related Art

A conventional chilled drink dispenser includes a base seat and a drink container for containing a drink (fruit juice) and ice cubes. The drink and ice cubes are mixed with each other to serve as a chilled drink.

The conventional chilled drink dispenser has a shortcoming, that is, the drink will be diluted by melted iced water to deteriorate (thin) the original taste of the drink.

It is therefore tried by the applicant to provide a chilled drink dispenser that can preserve the original taste of the drink without being diluted by the melted iced water.

### SUMMARY OF THE INVENTION

A primary object of the present invention is to provide a chilled drink dispenser including a drink container. The drink container has an ice chamber at its center. The ice chamber has an opening on its top for filling ice cubes without mixing with the drink. Accordingly, the chilled drink dispenser can preserve the original taste of the drink without being diluted by the melted iced water.

To achieve the above and other objects, the chilled drink dispenser of the present invention includes: a drink container for containing a drink, the drink container having an ice chamber at its center, the ice chamber having an opening on its top for filling ice cubes; a strainer member having a reception sink for engaging with a bottom section of the drink container, a drain structure being formed in the reception sink in alignment with the ice chamber, whereby melted iced water can be drained out through the drain structure; and a bottom basin, a top end of the bottom basin being engaged with an outer periphery of the strainer member. The bottom basin has a reservoir. After being drained out through the drain structure, the melted iced water will fall into the reservoir.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectional view of the chilled drink dispenser of the present invention, showing that a drink is contained in the drink container, while ice cubes are contained in the ice chamber;

FIG. 2 is a sectional exploded view of the chilled drink dispenser of the present invention;

FIG. 3 is a perspective exploded view of the chilled drink dispenser of the present invention;

FIG. 4 is a sectional view taken along line 4-4 of FIG. 1; and

FIG. 5 is a top view of the strainer member of the present invention.

### DETAILED DESCRIPTION OF THE PREFERRED EMBODIMENTS

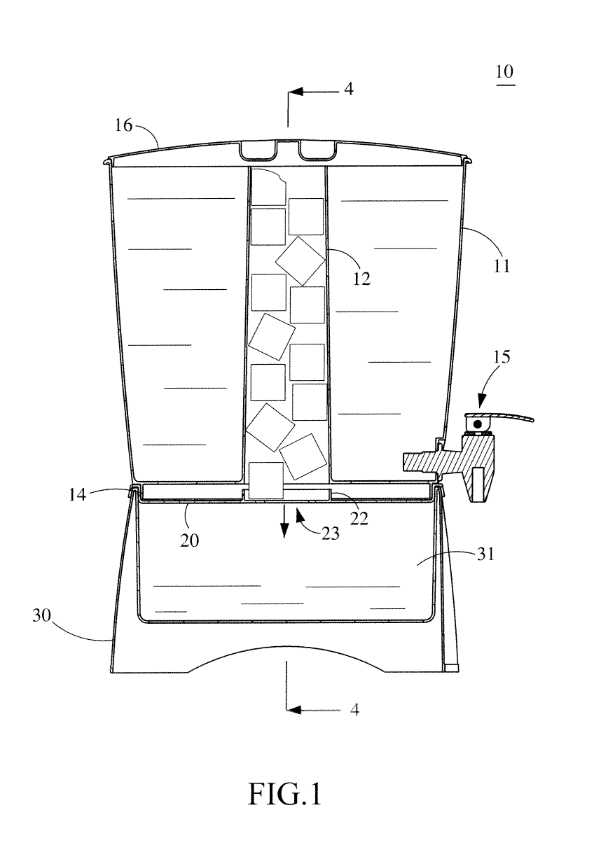

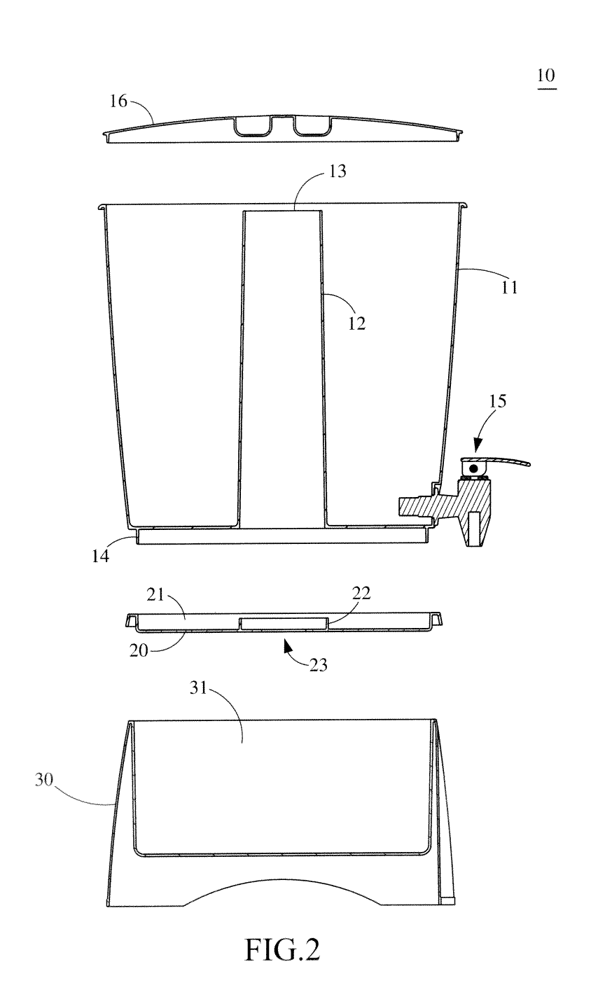

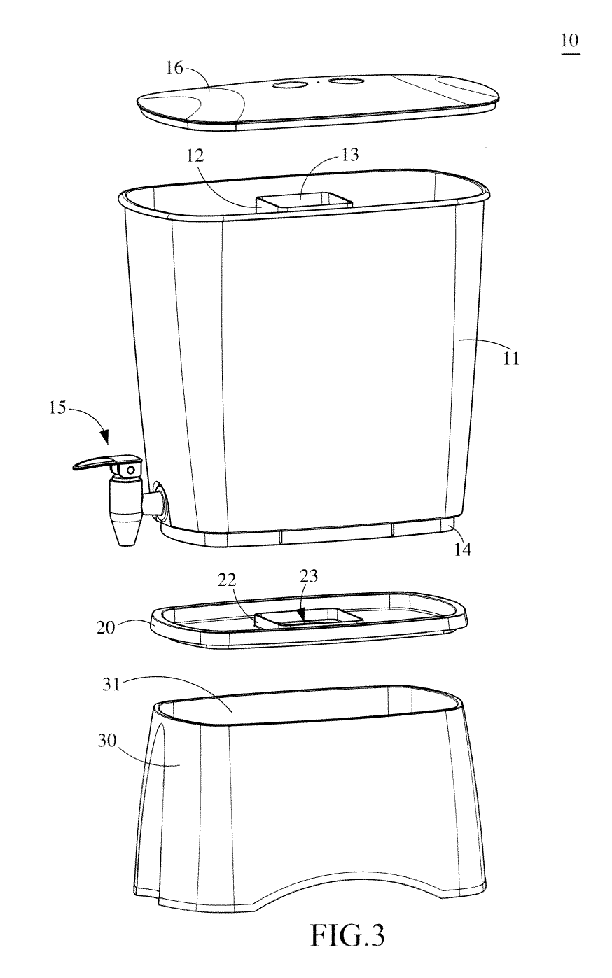

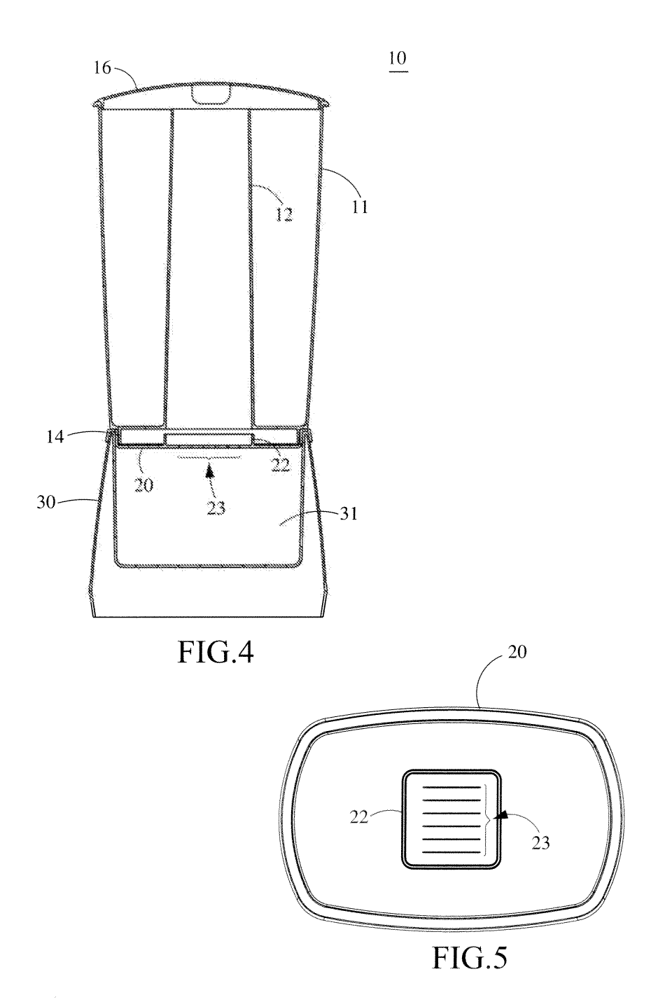

Please refer to FIGS. 1 to 4. The chilled drink dispenser 10 of the present invention includes a drink container 11, a strainer member 20 connected with a bottom section of the drink container 11 and a bottom basin 30 connected with a periphery of the strainer member 20.

The drink container 11 has an ice chamber 12 at its center. The ice chamber 12 has an opening 13 on its top for filling and replenishing ice cubes as needed. The bottom section of the drink container 11 has a hub section 14. In addition, the drink container 11 has a tap 15 installed on a wall of the drink container 11. By means of operating the tap 15, the chilled drink (fruit juice) in the drink container 11 can be dispensed from a spout of the tap 15.

The drink container 11 further includes an upper cover 16 for blocking a top opening of the drink container 11 to prevent any external objects from entering the drink container 11.

The strainer member 20 has a reception sink 21. The hub section 14 of the drink container 11 is inserted in the reception sink 21 to engage the drink container 11 with the strainer member 20. A water-retaining wall 22 is formed on the strainer member 20 in the reception sink 21. A drain structure 23 (as shown in FIG. 5) is formed in the water-retaining wall 22. The drain structure 23 can be a slotted drain structure, perforated drain structure or the like drain structure. The drain structure 23 is aligned with the ice chamber 12, whereby the melted iced water can be drained out through the drain structure 23.

A top end of the bottom basin 30 is engaged with an outer periphery of the strainer member 20. The bottom basin 30 has a reservoir 31. After being drained out through the drain structure 23, the melted iced water will fall into the reservoir 31 of the bottom basin 30.

In conclusion, the drink container 11 of the present invention serves to contain a drink therein and ice cubes can be filled into the ice chamber 12 in isolation from the drink. In this case, unlike the conventional drink dispensers, the original taste of the drink can be preserved without being diluted by the melted iced water.

The above embodiments are only used to illustrate the present invention, not intended to limit the scope thereof. It is understood that many changes or modifications of the above embodiments can be made by those who are skilled in this field without departing from the spirit of the present invention. The scope of the present invention is limited only by the appended claims.

What is claimed is:

1. A chilled drink dispenser comprising:
a drink container for containing a drink, the drink container having an ice chamber at its center, the ice chamber having an opening on its top for filling ice cubes;
a strainer member having a reception sink for engaging with a bottom section of the drink container, a drain structure being formed in reception sink in alignment with the ice chamber, whereby melted iced water can be drained out through the drain structure; and
a bottom basin, a top end of the bottom basin being engaged with an outer periphery of the strainer member, the bottom basin having a reservoir, whereby after drained out through the drain structure, the melted iced water will fall into the reservoir.

2. The chilled drink dispenser as claimed in claim 1, wherein a water-retaining wall is formed on the strainer member in the reception sink, the drain structure being formed in the water-retaining wall.
